(19) United States
(12) Patent Application Publication
(10) Pub. No.: US 2012/0291302 A1
(43) Pub. Date: Nov. 22, 2012

(54) NOISE-REDUCING LAUNDRY DRUM FOR A HOUSEHOLD APPLIANCE

(75) Inventor: Gerhard Stegerwald, New Bern, NC (US)

(73) Assignee: BSH HOME APPLIANCES CORPORATION, Huntington Beach, CA (US)

(21) Appl. No.: 13/108,169

(22) Filed: May 16, 2011

(51) Int. Cl. F26B 11/02; D06F 25/00

(52) U.S. Cl. 34/108; 68/139

(57) ABSTRACT

A drum for a household appliance, and a household appliance having a drum, wherein the drum includes a cylindrical shell, a front sheet on a front of the cylindrical shell, and a rear sheet on a rear of the cylindrical shell, wherein a portion of the cylindrical shell includes a noise-dampening coating.

### FIELD OF THE INVENTION

The present invention is directed to a noise-reducing laundry drum for a domestic household appliance, and more particularly, to a laundry drum having a noise-reducing coating or liner, and more particularly, to a domestic household appliance having a laundry drum having a noise-reducing coating or liner.

### BACKGROUND OF THE INVENTION

A domestic household appliance, such as a laundry washer or dryer, generally includes a housing having a door that covers an opening for accessing the interior of the appliance. The household appliance commonly includes a washing unit or drying unit in the interior of the appliance housing. The washing unit of a washer includes a tub having a cylindrical washing drum rotatably mounted inside the tub and a driver device for driving the rotating drum. The drying unit of a dryer includes a cylindrical drum rotatably mounted inside the housing and a driver device for driving the rotating drum.

Front-load clothes washers and dryers, which have a door positioned on the front of the appliance, have become increasingly popular in recent years for household use. Such front-load washers and dryers commonly include glass or see-through portions in the door to allow an operator to monitor the laundry while it is in the rotating drum.

In operation, the door of the appliance is opened and clothes or laundry are inserted into the household appliance through the opening and placed in the rotating drum and the door is then closed. In the case of a washer, the household appliance wets the laundry to be washed with washing liquid and mechanically moves the laundry to release contaminants from the laundry, for example, during a low speed tumbling cycle in which the drive system rotates the drum at a low speed. In the case of a dryer, the household appliance tumbles and mechanically moves the laundry within the drum, for example, while heating the air within the drum and/or extracting moisture from the air within the drum to dry the laundry.

Household appliances that operate quietly also have become increasingly popular in recent years for household use. During the rotation of the drum of a front-load washer or dryer, the laundry may be lifted upward within the drum along the circumferential interior surface of the drum before dropping back toward a lower area of the drum. The falling laundry items, particularly falling laundry items having metal parts (e.g., buckles, buttons, etc.), may emit noise when the items contact the interior surface of the drum.

### SUMMARY OF THE INVENTION

These problems and others are addressed by the present invention, a first exemplary embodiment of which comprises a drum for a household appliance, the drum comprising a cylindrical shell, a front sheet on a front of the cylindrical shell, and a rear sheet on a rear of the cylindrical shell, wherein a portion of the cylindrical shell includes a noise-dampening coating.

Another exemplary embodiment of the invention comprises a household appliance including a housing having a door formed in a front panel thereof for accessing an interior of the housing, and a rotating drum disposed within the housing, the drum comprising a cylindrical shell, a front sheet on a front of the cylindrical shell, and a rear sheet on a rear of the cylindrical shell, wherein a portion of the cylindrical shell includes a noise-dampening coating.

Yet another exemplary embodiment of the invention comprises a household appliance comprising a housing having a door formed in a front panel thereof for accessing an interior of the housing, and a rotating drum disposed within the housing, the drum including a cylindrical shell, a front sheet on a front of the cylindrical shell, and a rear sheet on a rear of the cylindrical shell, wherein a portion of one of the cylindrical shell, the front sheet, and the rear sheet includes means for dampening noise.

In this manner, the embodiments directly address the particular source of noise resulting from falling laundry items having metal parts (e.g., buckles, buttons, etc.) contacting the interior surface of the drum. More particularly, the embodiments can coat the inside of the drum directly at the starting point/source of the noise. The inside of the drum can be coated or lined (i.e., directly coated or lined) with a noise-dampening coating or material, such as an elastic material, rubber, synthetic rubber, or any other noise-dampening material. The drum can be pre-coated with the noise-dampening coating or material during the assembly process, or post-coated with the noise-dampening coating or material subsequent to the assembly of the drum within the household appliance.

The drum can be partially or fully (i.e., entirely or completely) coated with the noise-dampening coating or material. For example, in an embodiment, only the circumferential drum shell may be coated with the noise-dampening coating. The noise-dampening coating may be provided on the interior surfaces of the drum, the outside surfaces of the drum, or on all parts of the drum.

The drum can be a dryer drum or a washer drum that is coated with an elastic material, rubber, synthetic rubber, or any other noise-dampening material to reduce the noise emitted by falling laundry items, especially of falling laundry items that have metal parts (e.g., buckles, buttons, etc.). The coating is applied directly at the source of the noise (metal or other hard items on clothing hitting the inside of the metal drum), thereby providing a greater level of noise reduction.

In an embodiment, the noise-dampening coating or material can have a low flame point and/or emit a large amount of CO, CO₂, NOₓ, or the like when exposed to high levels of heat or fire, thereby providing an additional advantage of smothering any fire that may occur inside the drum of the appliance, for example, as a result of an overheating of laundry in the household appliance. In this manner, the noise-dampening coating can provide a fire retardant/containment/abatement function, in addition to reducing noise.

Furthermore, the noise-dampening coating can be provided in various colors, thereby improving aesthetic qualities of the portions of the drum that are visible to a user.

Other features and advantages of the present invention will become apparent to those skilled in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 is a front elevation view of a washer.

FIG. 2 is a front elevation view of a dryer.

FIG. 3A is a schematic, cross-sectional view of a washer.

FIG. 3B is a schematic, cross-sectional view of a dryer.

FIG. 4 is a schematic, cross-sectional view of a drum of a household appliance according to an exemplary embodiment of the invention.

FIG. 5 is a schematic, cross-sectional view of a drum of a household appliance taken along section V-V of FIG. 4.

FIG. 6 is a schematic, cross-sectional view of a drum of a household appliance according to an exemplary embodiment of the invention.

FIG. 7 is a schematic, cross-sectional view of a drum of a household appliance taken along section VII-VII of FIG. 6.

FIG. 8 is a schematic, cross-sectional view of a drum of a household appliance according to an exemplary embodiment of the invention.

FIG. 9 is a schematic, cross-sectional view of a drum of a household appliance taken along section IX-IX of FIG. 8.

FIG. 10 is a schematic, cross-sectional view of a drum of a household appliance according to an exemplary embodiment of the invention.

FIG. 11 is a schematic, cross-sectional view of a drum of a household appliance taken along section XI-XI of FIG. 10.

FIG. 12 is a perspective view of a conventional drum of a household appliance.

FIG. 13 is a perspective view of a drum of a household appliance according to an exemplary embodiment of the invention.

FIG. 14 is a perspective, cross-sectional view of the drum of FIG. 13.

### DETAILED DESCRIPTION OF THE EXEMPLARY EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

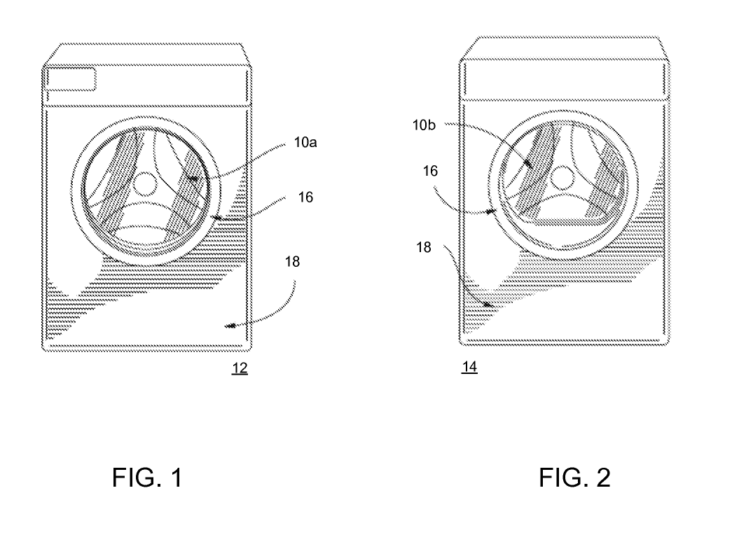

Referring now to the drawings, FIGS. 1-14 illustrate exemplary embodiments of a drum 10a, 10b of a household appliance, such as a washer 12 or dryer 14.

As illustrated in FIGS. 1 and 2, a household appliance, such as a front-loading clothes washer 12 or a dryer 14, includes a housing 18 having a door 16 that provides access to an interior of the appliance housing 18.

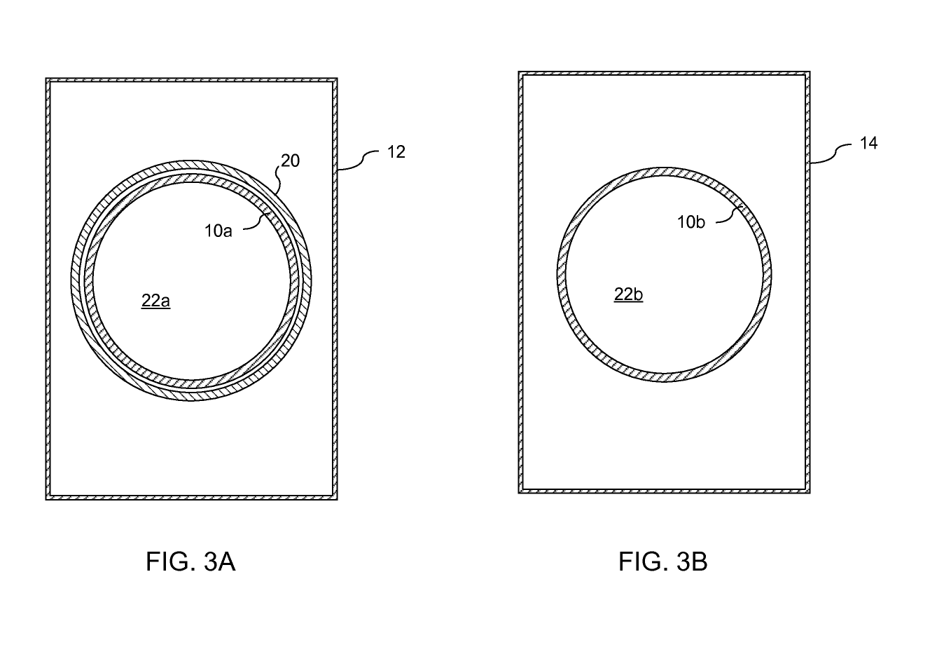

Referring to FIG. 3A, a household appliance, such as a washer 12, includes a tub 20 in the housing 18 and a drum 10a rotatably mounted in the tub 20 for receiving laundry to be washed. The drum 10a has an axis of rotation and an opening for inserting the laundry into an interior 22a of the drum 10a. A drive system (not shown) rotates the drum 10a inside the tub 20 about an axis of the drum 10a. A stationary gasket (not shown), such as a bellow seal, can couple the tub 20 to the housing 12 such that the tub 20 and drum 10a assembly can move relative to the housing 12.

Referring to FIG. 3B, a household appliance, such as a dryer 14, includes a drum 10b rotatably mounted in the housing 14 for receiving laundry to be dried. The drum 10b has an axis of rotation and an opening for inserting the laundry into an interior 22b of the drum 10b. A drive system (not shown) rotates the drum 10b about an axis of the drum 10b.

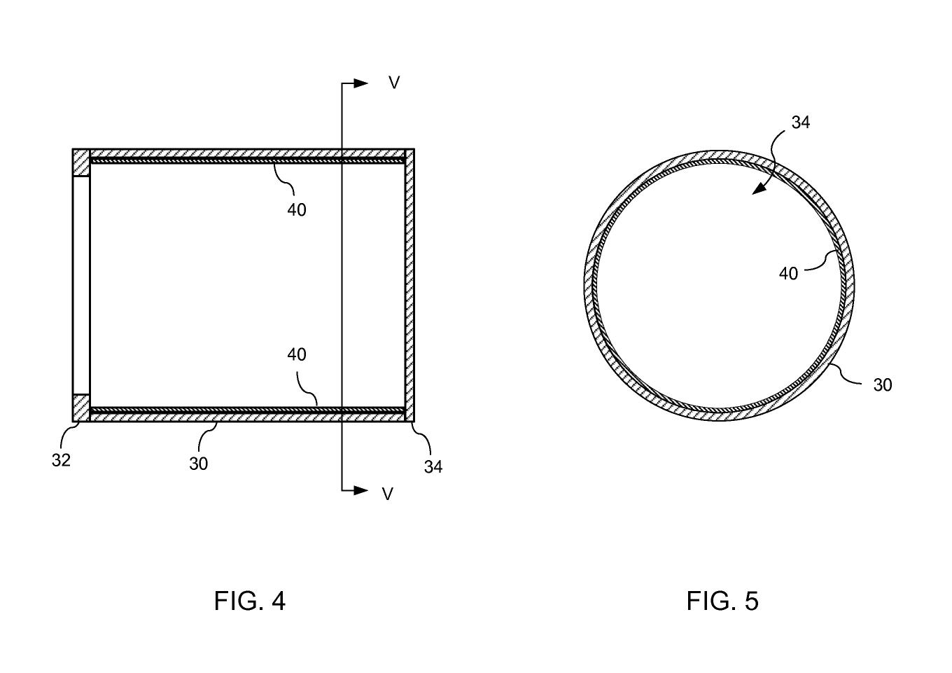

With reference to FIGS. 4-11, exemplary embodiments of a drum 10a, 10b for a household appliance will now be described.

FIGS. 4 and 5 exemplarily illustrate a drum 10a, 10b including a cylindrical shell 30, a front sheet 32 on a front circumferential end of the cylindrical shell 30, and a rear sheet 34 on a rear circumferential end of the cylindrical shell 30. The front sheet 32 includes an opening for inserting the laundry into an interior 22 of the drum 10a, 10b. A portion of the cylindrical shell 30 includes a noise-dampening coating 40. In this manner, the embodiments directly address the particular source of noise resulting from falling laundry items having metal parts (e.g., buckles, buttons, etc.) contacting the interior surface of the drum 10a, 10b by coating (e.g., directly coating) a surface of the cylindrical shell 30 of the drum 10a, 10b.

As shown in FIGS. 4 and 5, a portion of the inside of the cylindrical shell 30 of the drum 10a, 10b can be coated or lined (i.e., directly coated or lined) with a noise-dampening coating or material 40, such as an elastic material, rubber, synthetic rubber, or any other noise-dampening material. The drum 10a, 10b can be pre-coated with the noise-dampening coating or material 40 during the assembly process, or post coated with the noise-dampening coating or material 40 subsequent to the assembly of the drum 10a, 10b within the household appliance.

In an embodiment, the noise-dampening coating or material 40 can have a low flame point and/or emit a large amount of CO, CO₂, NOₓ, or the like when exposed to high levels of heat or fire, thereby providing an additional advantage of smothering any fire that may occur inside the drum 10a, 10b of the appliance, for example, as a result of an overheating of laundry in the household appliance. In this manner, the noise-dampening coating 40 can provide a fire retardant/containment/abatement function, in addition to reducing noise.

Furthermore, the noise-dampening coating 40 can be provided in various colors, thereby improving aesthetic qualities of the portions of the drum that are visible to a user.

One or more surfaces of the drum 10a, 10b can be partially or fully (i.e., entirely or completely) coated with the noise-dampening coating or material 40. For example, in an embodiment, only the circumferential drum shell 30 may be partially or fully coated with the noise-dampening coating 40. In other embodiments, the noise-dampening coating 40 may be provided on an interior surface of the drum 10a, 10b, an outside or exterior surface of the drum 10a, 10b, or on all parts of the drum 10a, 10b (i.e., interior and exterior surfaces of the drum 10a, 10b).

For example, with reference again to the embodiment of FIGS. 4 and 5, an entire interior surface of the cylindrical shell 30 of the drum 10a, 10b can include a layer of the noise-dampening coating 40.

FIGS. 4-11 schematically illustrate the features of the drum 10a, 10b for simplicity. One of ordinary skill in the art will recognize that the drum 10a, 10b can have other shapes, contours, or features. For example, the drum 10a, 10b can include curved or contoured front and rear sheets 32, 34, perforated portions for permitting washing fluid or air to flow through portions of the cylindrical shell 30 or front and rear sheets 32, 34 of the drum 10a, 10b, etc. The drum 10a, 10b can include paddles (not shown) coupled to or integrally formed with the interior surface of the cylindrical shell 30 of the drum 10a, 10b for lifting the laundry in the drum 10a, 10b as the drum 10a, 10b rotates and/or for raining washing fluid onto the laundry during a cleaning/rinsing cycle. The front and rear sheets 32, 34 of the drum 10a, 10b can include reinforcing features or supports for mounting the drum 10a, 10b within the household appliance and/or driving the rotation of the drum 10a, 10b within the housing of the household appliance during operation of the household appliance.

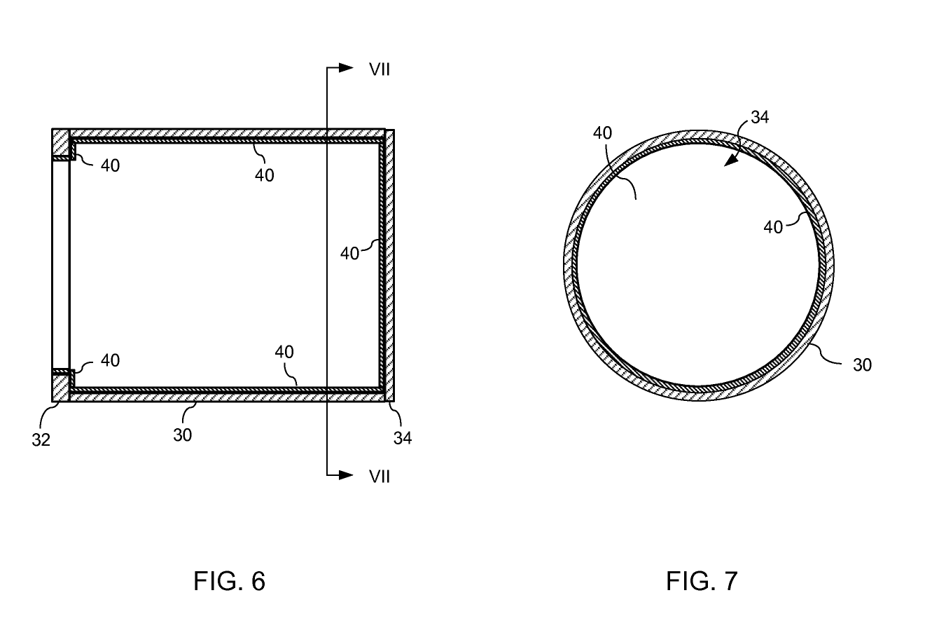

With reference to FIGS. 6 and 7, another exemplary embodiment of a drum 10a, 10b will now be described. The interior surface (e.g., entire interior surface) of the cylindrical shell 30 of the drum 10a, 10b can include a layer of, or be coated with, a noise-dampening coating 40. A portion of the front sheet 32 and/or the rear sheet 34 can include a noise-dampening coating 40. In an embodiment, the entire interior surface of the drum 10a, 10b, including the interior surfaces of the cylindrical shell 30, the front sheet 32, and the rear sheet 34 can include the noise-dampening coating 40 such that any surface that can be contacted by the laundry has the noise-dampening coating 40, thereby reducing or eliminating noise resulting from falling laundry items having metal parts (e.g., buckles, buttons, etc.) contacting the interior surface of the drum 10a, 10b.

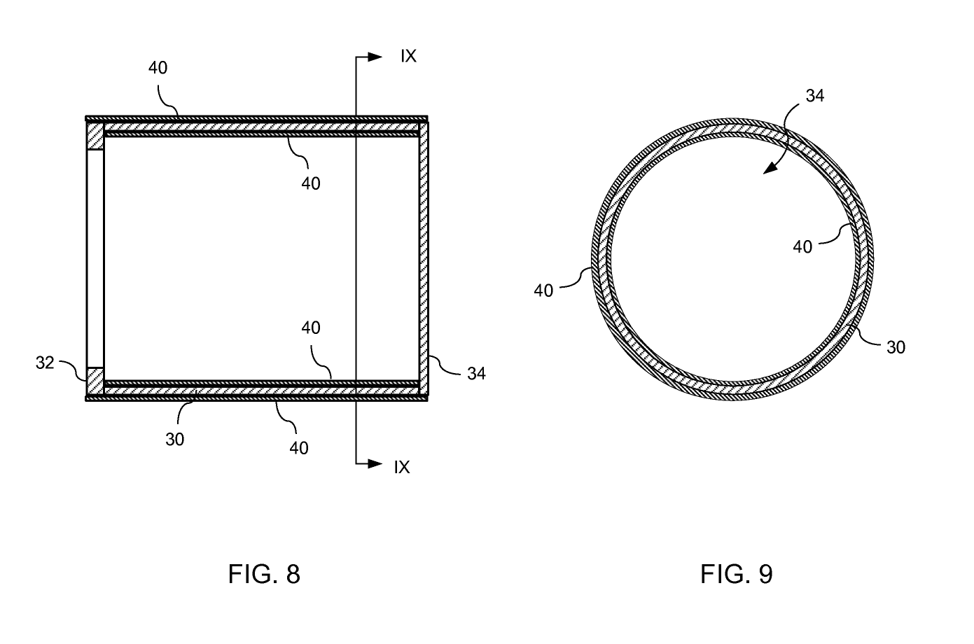

With reference to FIGS. 8 and 9, another exemplary embodiment of a drum 10a, 10b will now be described. The interior surface and the exterior surface (e.g., a portion of the interior surface or the entire interior surface, and/or a portion of the exterior surface or the entire exterior surface) of the cylindrical shell 30 of the drum 10a, 10b can include a layer of, or be coated with, a noise-dampening coating 40.

In other embodiments, only the exterior surface of the cylindrical shell may have the noise-dampening coating 40. Furthermore, a portion of the front sheet 32 and/or the rear sheet 34 can include the noise-dampening coating 40.

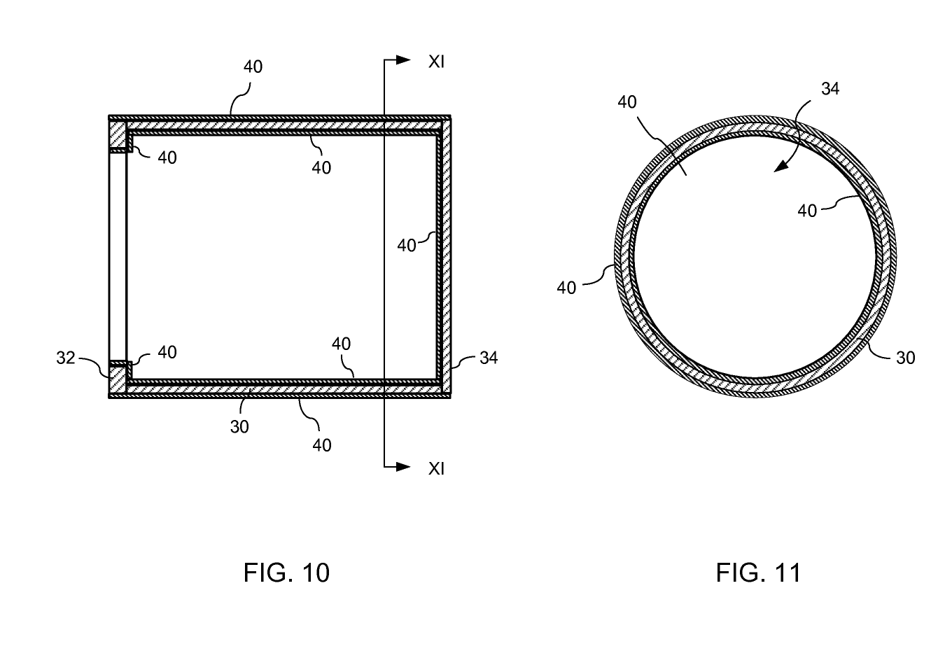

For example, with reference to the exemplary embodiment of FIGS. 10 and 11, the entire interior surface of the drum 10a, 10b, including the interior surfaces of the cylindrical shell 30, the front sheet 32, and the rear sheet 34, can include a noise-dampening coating 40 such that any surface that can be contacted by the laundry has the noise-dampening coating 40, thereby reducing or eliminating noise resulting from falling laundry items having metal parts (e.g., buckles, buttons, etc.) contacting the interior surface of the drum 10a, 10b. The exterior surface (e.g., a portion of the exterior surface or the entire exterior surface) of the cylindrical shell 30 of the drum 10a, 10b can include a layer of, or be coated with, a noise-dampening coating 40.

In other embodiments, a portion of the exterior surfaces of the front sheet 32 and/or the rear sheet 34, or the entire surface of the front sheet 32 and/or the rear sheet 34, can include a noise-dampening coating 40.

Additionally, other features or elements formed on or coupled to the drum 10a, 10b can include a noise-dampening coating 40. For example, curved or contoured portions, perforated portions, paddles, reinforcing features or supports for mounting the drum 10a, 10b within the household appliance and/or driving the rotation of the drum 10a, 10b within the household appliance, or the like can include a noise-dampening coating 40.

The drum 10a, 10b can be a washer drum (i.e., a drum for a washer 12) or a dryer drum (i.e., a drum for a dryer 14) that is coated with an elastic material, rubber, synthetic rubber, or any other noise-dampening material (e.g. 40) to reduce the noise emitted by falling laundry items, especially of falling laundry items that have metal parts (e.g., buckles, buttons, etc.). In this manner, the coating 40 can be applied directly at the source of the noise (metal or other hard items on clothing hitting the inside of the metal drum), thereby providing a greater level of noise reduction.

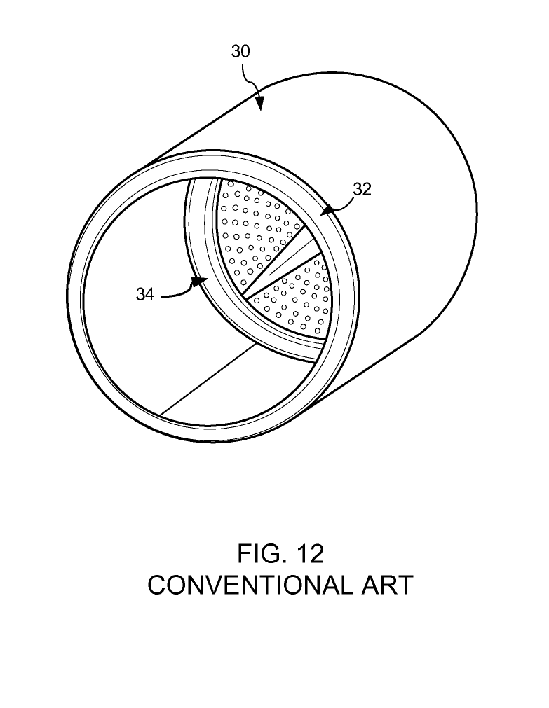

With reference to FIGS. 12-14, exemplary embodiments of a drum for a household appliance will now be described. The exemplary embodiments are illustrated for a drum 10b of a dryer 12. However, one of ordinary skill in the art will recognize that the drum is not limited to the drum 10b of a dryer 12 and can include, for example, a drum 10a for a washer 10.

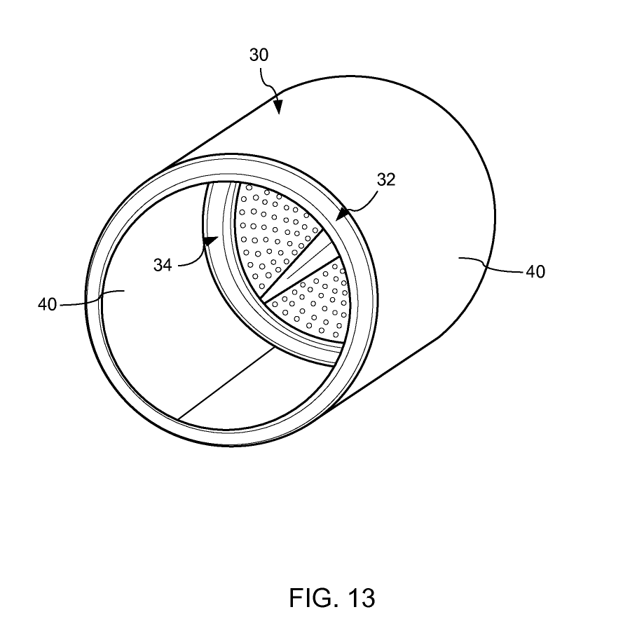

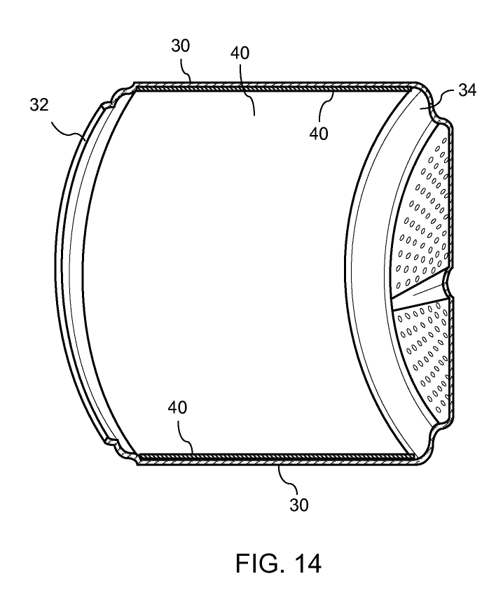

FIG. 12 illustrates a drum 10b without a noise-dampening coating 40. FIGS. 13 and 14 exemplarily illustrate an embodiment of a drum 10b in which an entire interior surface of the cylindrical shell 30 of the drum 10b includes (i.e., is coated with) a noise-dampening coating 40. In other embodiments, a portion of the interior surface, or the entire interior surface, of the front sheet 32 can be coated with a noise-dampening coating 40. In other embodiments, a portion of the interior surface (e.g., the circumferential ring), or the entire interior surface, of the rear sheet 34 can be coated with a noise-dampening coating 40.

Another exemplary embodiment is directed to a household appliance including a housing 18 having a door 16 formed in a front panel thereof for accessing an interior 22 of the housing 18, and a rotating drum (e.g., 10a, 10b) disposed within the housing 18. The drum (e.g., 10a, 10b) can include a cylindrical shell 30, a front sheet 32 on a front of the cylindrical shell 30, and a rear sheet 34 on a rear of the cylindrical shell 30. A portion of the cylindrical shell 30 can include means for dampening noise (e.g., 40).

In another embodiment, a portion of one of the cylindrical shell 30, the front sheet 32, and the rear sheet 34 can include means for dampening noise (e.g., 40). The portion can include the interior and/or the exterior surfaces of one or more of the cylindrical shell 30, front sheet 32, and rear sheet 34.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

What is claimed is:

1. A drum for a household appliance, the drum comprising:
a cylindrical shell;
a front sheet on a front of the cylindrical shell; and
a rear sheet on a rear of the cylindrical shell,
wherein a portion of the cylindrical shell includes a noise-dampening coating.

2. The drum of claim 1, wherein the noise-dampening coating includes an elastic material.

3. The drum of claim 1, wherein the noise-dampening coating includes one of a rubber material and a synthetic rubber material.

4. The drum of claim 1, wherein a portion of an interior surface of the cylindrical shell includes the noise-dampening coating.

5. The drum of claim 1, wherein a portion of an exterior surface of the cylindrical shell includes the noise-dampening coating.

6. The drum of claim 4, wherein an entire interior surface of the cylindrical shell includes the noise-dampening coating.

7. The drum of claim 5, wherein an entire exterior surface of the cylindrical shell includes the noise-dampening coating.

8. The drum of claim 1, wherein a portion of an interior surface and a portion of an exterior surface of the cylindrical shell includes the noise-dampening coating.

9. The drum of claim 8, wherein an entire interior surface and an entire exterior surface of the cylindrical shell includes the noise-dampening coating.

10. The drum of claim 1, wherein a portion of the front sheet includes the noise-dampening coating.

11. The drum of claim 1, wherein a portion of the rear sheet includes the noise-dampening coating.

12. The drum of claim 1, wherein a portion of the front sheet and the rear sheet includes the noise-dampening coating.

13. The drum of claim 10, wherein an interior surface of the front sheet includes the noise-dampening coating.

14. The drum of claim 11, wherein an interior surface of the rear sheet includes the noise-dampening coating.

15. The drum of claim 10, wherein an entire interior surface of the front sheet includes the noise-dampening coating.

16. The drum of claim 11, wherein an entire interior surface of the rear sheet includes the noise-dampening coating.

17. The drum of claim 10, wherein an exterior surface of the front sheet includes the noise-dampening coating.

18. The drum of claim 11, wherein an exterior surface of the rear sheet includes the noise-dampening coating.

19. The drum of claim 10, wherein an entire exterior surface of the front sheet includes the noise-dampening coating.

20. The drum of claim 11, wherein an entire exterior surface of the rear sheet includes the noise-dampening coating.

21. The drum of claim 1, wherein the drum is a dryer drum.

22. The drum of claim 1, wherein the drum is a washer drum.

23. A household appliance comprising:
a housing having a door formed in a front panel thereof for accessing an interior of the housing; and
a rotating drum disposed within the housing, the drum comprising:
a cylindrical shell;
a front sheet on a front of the cylindrical shell; and
a rear sheet on a rear of the cylindrical shell,
wherein a portion of the cylindrical shell includes a noise-dampening coating.

24. The household appliance of claim 23, wherein the noise-dampening coating includes one of an elastic material, a rubber material, and a synthetic rubber material.

25. The household appliance of claim 23, wherein a portion of an interior surface of the cylindrical shell includes the noise-dampening coating.

26. The household appliance of claim 23, wherein a portion of an exterior surface of the cylindrical shell includes the noise-dampening coating.

27. The household appliance of claim 25, wherein an entire interior surface of the cylindrical shell includes the noise-dampening coating.

28. The household appliance of claim 26, wherein an entire exterior surface of the cylindrical shell includes the noise-dampening coating.

29. The household appliance of claim 23, wherein a portion of an interior surface and a portion of an exterior surface of the cylindrical shell includes the noise-dampening coating.

30. The household appliance of claim 1, wherein a portion of one of the front sheet and the rear sheet includes the noise-dampening coating.

31. The household appliance of claim 25, wherein a portion of one of an interior surface of the front sheet and an interior surface of the rear sheet includes the noise-dampening coating.

32. The household appliance of claim 26, wherein a portion of one of an exterior surface of the front sheet and an exterior surface of the rear sheet includes the noise-dampening coating.

33. The household appliance of claim 23, wherein the household appliance is a dryer.

34. The household appliance of claim 23, wherein the household appliance is a washer.

35. A household appliance comprising:
a housing having a door formed in a front panel thereof for accessing an interior of the housing; and
a rotating drum disposed within the housing, the drum comprising:
a cylindrical shell;
a front sheet on a front of the cylindrical shell; and
a rear sheet on a rear of the cylindrical shell,
wherein a portion of one of the cylindrical shell, the front sheet, and the rear sheet includes means for dampening noise.

36. The drum of claim 1, wherein the noise-dampening coating includes a fire suppressant noise-dampening coating.

37. The household appliance of claim 23, wherein the noise-dampening coating includes a fire suppressant noise-dampening coating.

38. The household appliance of claim 35, wherein the means for dampening noise includes means for suppressing a fire in the drum.
